(19) United States
(12) Patent Application Publication
(10) Pub. No.: US 2016/0238502 A1
(43) Pub. Date: Aug. 18, 2016

(54) METHOD AND SYSTEM FOR DETERMINING HARDNESS INFORMATION OF COMPONENTS

(71) Applicant: Caterpillar Inc., Peoria, IL (US)

(72) Inventors: Anthony S. Wilshire, Peoria, IL (US); Dong Fei, Peoria, IL (US)

(73) Assignee: Caterpillar Inc., Peoria, IL (US)

(21) Appl. No.: 15/141,073

(22) Filed: Apr. 28, 2016

(51) Int. Cl. G01N 3/40; G01N 27/02

(52) U.S. Cl. CPC G01N 3/40; G01N 27/025; B23B 2228/24; B23B 2270/48

(57) ABSTRACT

A method for determining hardness information of a component is disclosed. The method comprises forming at least one hole of a predetermined depth at a predetermined location on a surface of the component, measuring the hardness information of the component at the predetermined depth through the hole using one of a probe and a drill, and filling the at least one hole with a filler material.

### TECHNICAL FIELD

The present disclosure relates to determination of hardness information for components of a machine and more specifically, to a method and a system for determining hardness information of the case-hardened components of the machine.

### BACKGROUND

Machines are equipped with components including idlers, rollers, track shoes, track chains, and sprockets among others. The components are heat treated to alter and improve their mechanical properties such as, but not limited to, hardness, strength, ductility, and toughness. The components are further inspected to determine the effect of heat treatment on their mechanical properties. Case-hardening is one of the heat treatment processes that is used to increase the hardness of a desired area of the component, while allowing other areas of the component to remain unaffected.

The current methods perform destructive testing for inspecting hardness of the case-hardened components. The destructive testing includes cutting out a cross-section of the component that is further analyzed for inspecting the hardness. Further, such methods consume a lot of time to inspect the components for conformance to part print. Also, the components that undergo the destructive testing cannot be reused leading to an increase in manufacturing costs. The current methods also include performing anon-destructive testing for inspecting hardness of the components. Such methods of performing non-destructive testing include electromagnetic methods, ultrasonic methods, among others. However, the accuracy of such methods decreases with increasing case-hardening depths of the components. Therefore, there is a need for providing improved method for inspecting hardness of the case-hardened components, that is reliable, efficient and that saves time and cost.

### SUMMARY OF THE DISCLOSURE

In one aspect of the present disclosure, a method for determining hardness information of a component is disclosed. The method comprises forming at least one hole of a predetermined depth at a predetermined location on a surface of the component, measuring the hardness information of the component at the predetermined depth through the hole using one of a probe and a drill, and filling the at least one hole with a filler material.

Other features and aspects of this disclosure will be apparent from the following description and the accompanying drawings.

### BRIEF DESCRIPTION OF THE DRAWINGS

FIG. 1 illustrates a side view of a machine having an undercarriage assembly, in accordance with the concepts of the present disclosure;

FIG. 2 illustrates a pictorial view of a component section of the undercarriage assembly being tested for hardness, in accordance with the concepts of the present disclosure;

FIG. 3 illustrates a sectional view of the component section taken along a sectional line 3-3′ of FIG. 2 and a probe for determining hardness information of the component, in accordance with an embodiment of the present disclosure;

FIG. 4 illustrates a sectional view of the component section taken along sectional line 3-3′ of FIG. 2 and a drill for determining hardness information of the component, in accordance with an alternate embodiment of the present disclosure; and

FIG. 5 illustrates a flowchart of a method for determining hardness information of the component section, in accordance with the concepts of the present disclosure.

### DETAILED DESCRIPTION

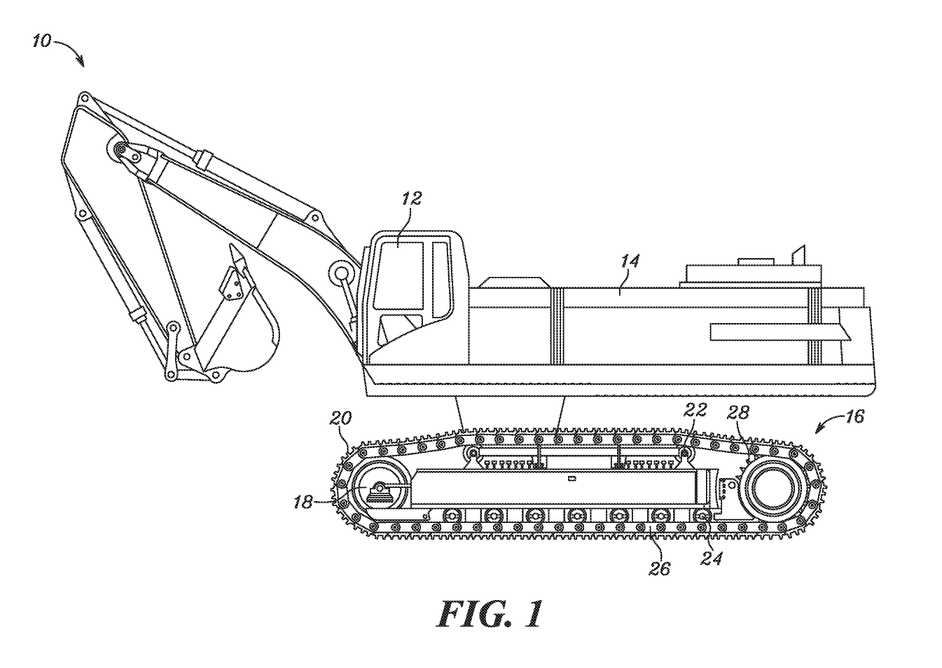

Referring to FIG. 1, a machine 10 includes a cabin 12, an upper assembly 14, and an undercarriage assembly 16 (hereinafter referred to as the assembly 16). The machine 10 further includes various other components which are not labeled in FIG. 1 for the purpose of simplicity. The assembly 16 includes a number of components such as, but not limited to, idlers 18, shoes 20, carriage rollers 22, rollers 24, track chains 26, and sprockets 28. It would be apparent to one skilled in the art that the examples of the machine 10 are an excavator, a dozer, a multi-terrain loader, a cold planer, a hydraulic mining shovel among others without departing from the meaning and the scope of the disclosure.

During manufacturing, various components, i.e. the components of the machine 10 are subjected to heat treatment processes to alter their mechanical properties. The heat treatment processes include through-hardening and case-hardening, among others. Further, the components are tested for determining the hardness information in order to satisfy quality parameters.

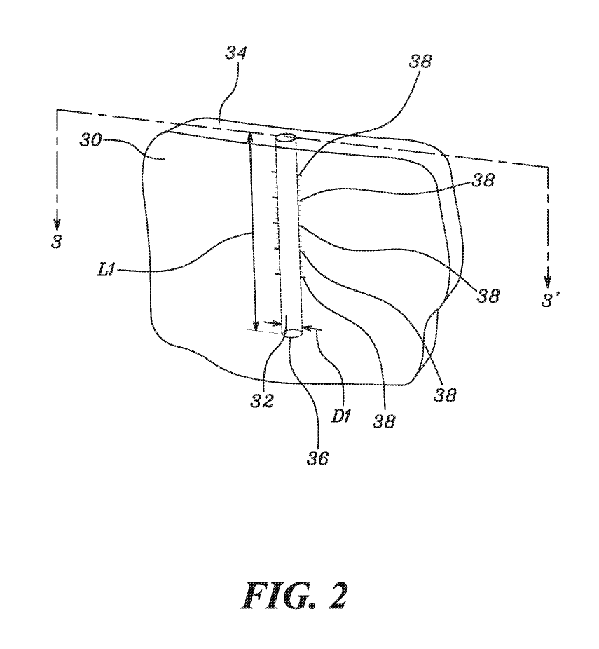

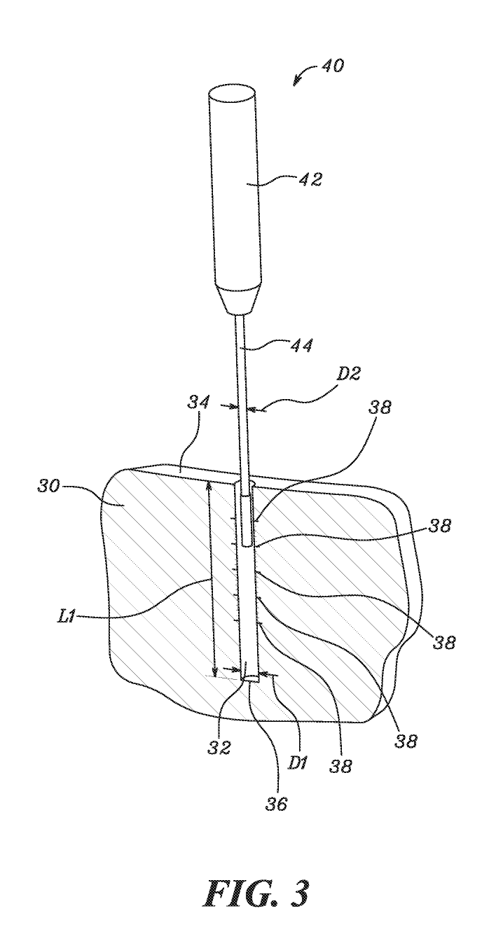

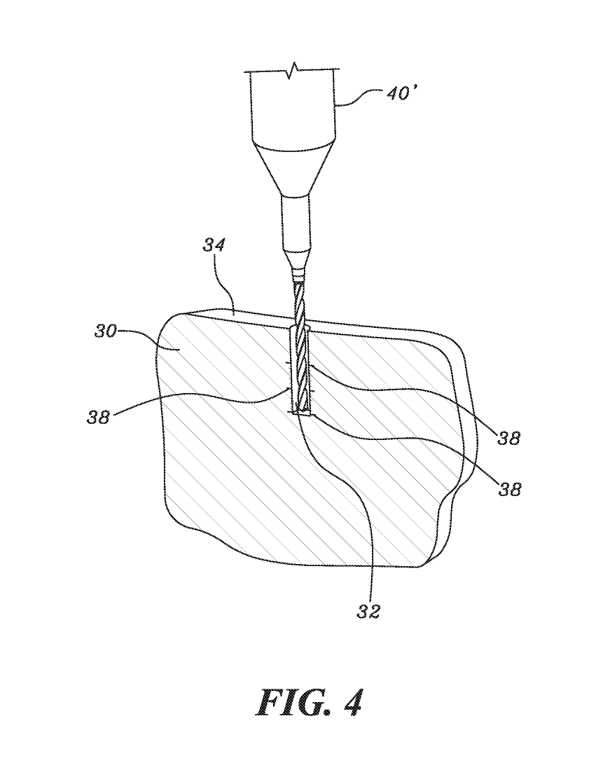

Referring to FIGS. 2 and 3, equipment for testing the effect of case-hardening on a component section 30 is provided, The component section 30 is the cross-section of the components such as, but not limited to, the idlers 18, the shoes 20, the carriage rollers 22, the rollers 24, the track chains 26, and the sprockets 28 (as shown in FIG. 1). In an embodiment, the equipment includes a. probe 40. The probe 40 is coupled to an electromagnetic instrument (not shown) which is further coupled to a computer (not shown). According to an alternate embodiment, the equipment includes a drill 40′ (as shown in FIG. 4). It will be apparent to one skilled in the art that the method for testing the effect of case-hardening may also be applicable for any other component, such as a flywheel, a cylinder block, an engine block among others without departing from the meaning and scope of the disclosure.

Referring to FIGS. 2 and 3, according to the embodiment, at least one hole 32 of a predetermined depth L1 and a diameter D1 is formed within the component section 30. The predetermined depth L1 of the hole 32 extends from a surface 34 of the component section 30 to an end 36 of the hole 32. The hole 32 is formed at a predetermined location on the surface 34 of the component section 30. The predetermined location corresponds to a non-critical location on the surface 34 of the component section 30 so that forming the hole 32 at the predetermined location does not cause any failure in the component section 30. It will be apparent to one skilled in the art that the predetermined depth L1 of the hole 32, the predetermined location of the hole 32, the diameter D1 of the hole 32 may vary without departing from the meaning and scope of the disclosure.

The probe 40 is inserted through the hole 32 at a number of depth points 38. The probe 40 includes a body portion 42 and a shaft portion 44. A diameter of the shaft portion 44 of the probe 40 is D2. The diameter D2 of the shaft portion 44 of the probe 40 is less than the diameter D1 of the hole 32 so that the shaft portion 44 easily slides within the hole 32. It will be apparent to one skilled in the art that the probe 40 may be any of electromagnetic (such as eddy current and Barkhausen noise), ultrasonic, optical, and other types of sensors without departing from the meaning and scope of the disclosure. In an embodiment of the disclosure, the probe 40 is a surface mount eddy current probe. The probe 40 uses the principle of electromagnetic induction to determine the hardness information of the component section 30 at the number of depth points 38.

When the probe 40 is inserted within the hole 32, an output is recorded. An alternating current is created in a coil (not shown) of the probe 40. The alternating current in the coil (not shown) of the probe 40 creates an alternating magnetic field in the coil (not shown) of the probe 40 which induces eddy currents in the component section 30. The eddy currents in the component section 30 create an opposing magnetic field to the alternating magnetic field created in the coil (not shown). The interaction between the two magnetic fields the alternating magnetic field in the coil (not shown) and the opposing magnetic field in the component section 30) produces the voltage output. The output is further correlated with the hardness information of the component section 30. Each depth point 38 from among a number of depth points 38 has an output proportional to the hardness information of the component section 30 at that particular depth point 38.

The computer (not shown) has an algorithm that compares the hardness information recorded at each of the depth points 38 with the print required hardness at each of the depth points 38 to inspect the quality of the component section 30. If the recorded hardness information conforms to the print required hardness, the component section 30 is passed for further manufacturing operations. If the recorded hardness information does not conform to the print required hardness, the component section 30 is discarded. After determining the hardness, the hole 32 is filled with a filler material to till the hole 32 formed on the surface 34 of the component section 30. It would be apparent to one skilled in the art that the filler material may include materials such as, but not limited to, rubber, epoxy, and composites without departing from the meaning and the scope of the disclosure.

Referring to FIG. 4, according to the alternate embodiment, the hardness information of the component section 30 is determined using a force-feedback from the drill 40′. The hole 32 is formed at the predetermined location on the surface 34 of the component section 30 by the drill 40′. During drilling, the pressure required to drill the hole 32 at the depth point 38 is recorded in the form of force-feedback from the drill 40′. The force-feedback includes force and torque measurements along three axes of three-dimensional space. The force feedback is adjusted to include the effect of tool wear. The hole 32 is drilled further down and the force-feedback is recorded at the number of depth points 38 within the hole 32. The force-feedback at each of the depth points 38 is correlated to the hardness information of the component section 30 at each of the depth points 38. The hardness information recorded at the number of depth points 38 is compared with the print required hardness at the depth points 38 to conform quality requirements of the component section 30. After the hardness is determined, the hole 32 is filled with the filler material.

### INDUSTRIAL APPLICABILITY

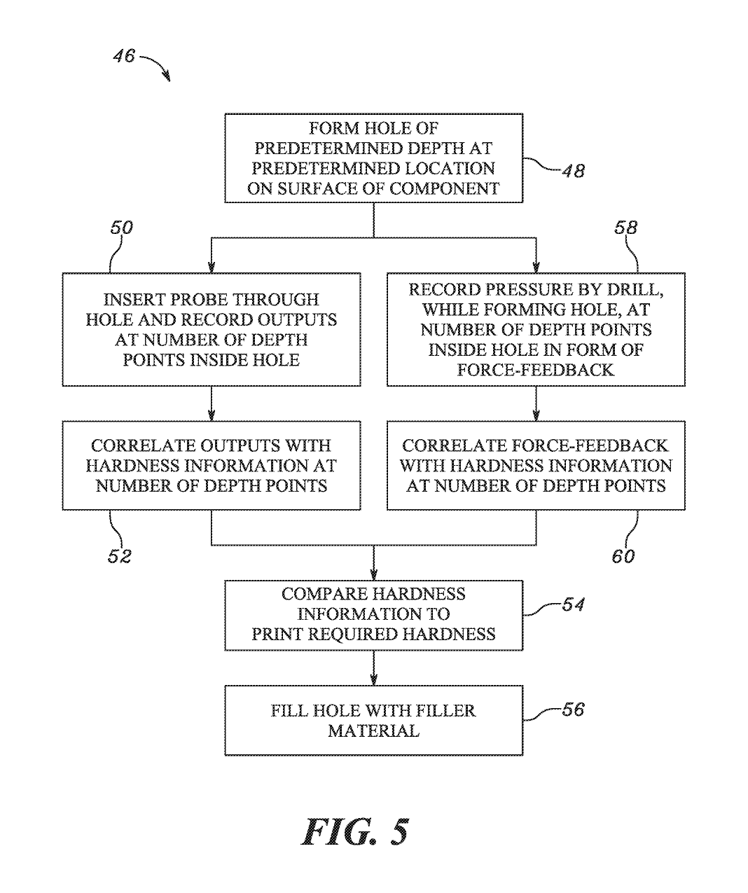

Referring to FIG. 5, a method 46 for determining the hardness information of the component section 30 is described in conjunction with FIGS. 2-3, according to the embodiment of the present disclosure. At step 48, the hole 32 of the predetermined depth L1 at the predetermined location is formed on the surface 34 of the component section 30. At step 50, the probe 40 is inserted through the hole 32 and outputs are recorded for the number of depth points 38 inside the hole 32. At step 52, the outputs recorded at each of the depth points 38 are correlated with the hardness information at each of the depth points 38. At step 54, the hardness information at each of the number of depth points 38 is compared with the print required hardness to inspect quality of the component section 30. At step 56, the hole 32 in the component section 30 is filled with the filler material after quality inspection.

Referring to FIG. 5, the method 46 for determining the hardness information of the component section 30 is described in conjunction with FIG. 4, according to the alternate embodiment of the present disclosure. At step 48, the hole 32 is formed at the predetermined location on the surface 34 of the component section 30. At step 58, during drilling, pressure at the number of depth points 38 inside the hole 32 is recorded in the form of force-feedback by the drill 40′. At step 60, the force-feedback recorded at each of the depth points 38 is compared with the hardness information at each of the depth points 38. At step 54, the hardness information at the depth points 38 is compared with the print required hardness to inspect quality of the component section 30. At step 56, the hole 32 in the component section 30 is filled with the filler material after quality inspection. It will be apparent to one skilled in the an that the step 48 and the step 58 take place simultaneously without departing from the meaning and scope of the disclosure. It will be apparent to one skilled in the art that the hole 32 may be machined at a particular depth for the hardness measurement and the hole 32 may he further machined upto another depth for the hardness measurement without departing from the meaning and the scope of the disclosure.

The present disclosure discloses the partially non-destructive method 46 for determining hardness information of the components of the machine 10. The method 46 reduces inspection time in contrast to the conventional destructive methods. Also, the hole 32 in the component section 30 is filled with the filler material after inspection, and thereby allows the component section 30 to be reused if the component section 30 meets the quality requirements. The method 46 is applied at various steps during a lifecycle of the component section 30, such as during manufacturing, and overhaul that helps to accurately determine the remaining life of the component section 30.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for determining hardness information of a component, the method comprising:
forming at least one hole of a predetermined depth at a predetermined location on a surface of the component;
measuring the hardness information of the component at the predetermined depth through the at least one hole using one of a probe and a drill; and
filling the at least one hole with a filler material.
